(19) United States
(12) Patent Application Publication
(10) Pub. No.: US 2007/0096619 A1
(43) Pub. Date: May 3, 2007

(54) Electron emission source comprising carbon-based material and photoelectric element, method of preparing the same, electron emission device and electron emission display device comprising the electron emission source

(75) Inventor: Kwang-Seok Jeong, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/588,351

(22) Filed: Oct. 27, 2006

(30) Foreign Application Priority Data
Oct. 31, 2005 (KR) 2005-103442

(51) Int. Cl. H01J 1/62

(52) U.S. Cl. 313/311; 313/497

(57) ABSTRACT

An electron emission source includes a carbon-based material and a photoelectric element, an electron emission device and an electron emission display include the electron emission sources. The electron emission source is prepared by preparing a composition for forming an electron emission source that contains a carbon-based material, a photoelectric element, and a vehicle, applying the composition to a substrate, and heating the composition applied to the substrate. The electron emission source includes the photoelectric element in addition to the carbon material, and thus can have a high luminance.

### CROSS-REFERENCE TO RELATED APPLICATIONS

This application claims the priority of Korean Patent Application No. 2005-103442, filed on Oct. 31, 2005, in the Korean Intellectual Property Office, the disclosure of which is incorporated herein in its entirety by reference.

### BACKGROUND OF THE INVENTION

1. Field of the Invention

Aspects of the present invention relate to an electron emission source, a method of preparing the same, and an electron emission device including the electron emission source, and an electron emission display device including the electron emission source, and more particularly, to an electron emission source including a carbon-based material and a photoelectric element, a method of preparing the same, an electron emission device including the electron emission source, and an electron emission display device including the electron emission source. The electron emission source includes the photoelectric element in addition to the carbon-based material, and thus can have a high luminance.

2. Description of the Related Art

Generally, electron emission devices use a hot cathode or a cold cathode as an electron emission source. Examples of electron emission devices using a cold cathode include a field emitter array (FEA) type, a surface conduction emitter (SCE) type, a metal insulator metal (MIM) type, a metal insulator semiconductor (MIS) type, and a ballistic electron surface emitting (BSE) type.

The FEA type utilizes the principle that when a material with a low work function or a high β function is used as an electron emission source, electrons are easily emitted in a vacuum due to an electric field difference. Devices including a tip structure primarily composed of Mo, Si, etc., and having a sharp end, and carbon-based materials such as graphite and diamond like carbon (DLC) as electron emission sources have been developed. Recently, nanomaterials such as nanotubes and nanowires have been used as electron emission sources.

The SCE type is formed by interposing a conductive thin film between a first electrode and a second electrode which are arranged on a first substrate so as to face each other and producing micro-cracks in the conductive thin film. When voltages are applied to the electrodes and an electric current flows the surface of the conductive thin film, electrons are emitted from the micro-cracks, causing them to become electron emission sources.

The MIM type and the MIS type include a metal-insulator-metal structure and a metal-insulator-semiconductor structure, respectively, as an electron emission source. When voltages are applied to two metals or to a metal and a semiconductor, electrons are emitted while migrating and accelerating from the metal or the semiconductor having a high electron potential to the metal having a low electron potential.

The BSE type utilizes the principle that when the size of a semiconductor is reduced to less than the mean free path of electrons in the semiconductor, electrons travel without scattering. An electron supplying layer composed of a metal or a semiconductor is formed on an ohmic electrode, and then an insulating layer and a metal thin film are formed thereon. When voltages are applied to the ohmic electrode and the metal thin film, electrons are emitted.

FEA type electron emission devices can be categorized as top gate types and under gate types according to the arrangement of the cathode electrode and the gate electrode and can be categorized as diodes, triodes, tetrodes, etc., according to the number of electrodes used.

Electron emission sources in the electron emission devices described above can be composed of carbon-based materials such as carbon nanotubes. Carbon nanotubes have excellent conductivity, electric field focusing effects, small work functions, and excellent electric field emission characteristics, and thus can function at a low driving voltage and can be used for large displays. Because of these advantages, carbon nanotubes are considered as an ideal electron emission material for electron emission sources.

Methods of preparing electron emission sources containing carbon nanotubes include, for example, a carbon nanotube growing method that uses chemical vapor deposition (CVD), etc., and a paste method that uses a composition containing already-formed carbon nanotubes and a vehicle. When using the paste method, the manufacturing costs decrease, and large-area electron emission sources can be obtained. Examples of forming electron emission sources using compositions that contain carbon nanotubes are disclosed, for example, in U.S. Pat. No. 6,436,221.

However, the luminance of electron emission devices that include conventional electron emission sources is unsatisfactory, and thus improvements in this regard are still required.

### SUMMARY OF THE INVENTION

Aspects of the present invention provides an electron emission source including a carbon-based material and a photoelectric element, a method of preparing the same, an electron emission device including the electron emission source, and an electron emission display device including the electron emission source.

According to an aspect of the present invention, there is provided an electron emission source including a carbon-based material and a photoelectric element.

According to another aspect of the present invention, there is provided a method of preparing an electron emission source, the method including: preparing a composition for forming electron emission sources that contains a carbon-based material, a photoelectric element, and a vehicle; applying the composition to a substrate; and heating the composition applied to the substrate.

According to another aspect of the present invention, there is provided an electron emission device including: a first substrate; a cathode electrode and an electron emission source which are arranged on the first substrate; a gate electrode which is arranged to be electrically insulated from the cathode electrode; and an insulating layer which is interposed between the cathode electrode and the gate electrode and insulates the cathode electrode and the gate electrode, wherein the electron emission source includes a carbon-based material and a photoelectric element. According to another aspect of the present invention, there is provided an electron emission display device including: a first substrate; cathode electrodes arranged on the first substrate; gate electrodes arranged so as to cross the cathode electrodes; an insulating layer interposed between the cathode electrodes and the gate electrodes to insulate the cathode electrodes and the gate electrodes; electron emission source holes formed at the points at which the cathode electrodes cross the gate electrodes; an electron emission source contained in the electron emission source holes; a second substrate arranged in parallel to the first substrate; an anode electrode arranged on the second substrate; and a phosphor layer arranged on the anode electrode, in which the electron emission source includes a carbon-based material and a photoelectric element.

According to another aspect of the present invention, an electron emission display device comprises a first substrate; a plurality of cathode electrodes arranged on the first substrate; a plurality of gate electrodes arranged so as to cross the cathode electrodes; an insulating layer interposed between the cathode electrodes and the gate electrodes to insulate the cathode electrodes and the gate electrodes; electron emission source holes formed at the points at which the cathode electrodes and the gate electrodes cross, each electron emission source hole containing an electron emission source, wherein the electron emission source comprises a carbon-based material and a photoelectric element; a second substrate arranged in parallel to the first substrate; an anode electrode arranged on the second substrate; and a phosphor layer arranged on the anode electrode, the phosphor layer comprising phosphors that are positioned to receive electrons from one of the electron emission sources and to emit light in the direction of the photoelectric element of the electron emission source.

Since the electron emission source includes the carbon-based material and the photoelectric element, the electron emission device and the electron emission display device including the electron emission source can have a high luminance.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic perspective view of an electron emission display device according to an embodiment of the present invention; and

FIG. 2 is a cross-sectional view taken along the line II-II of FIG. 1.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

An electron emission source according to an embodiment of the present invention includes a carbon-based material having good conductivity and electron emission characteristics and a photoelectric element.

The carbon-based material emits electrons to a phosphor layer to excite phosphors when the electron emission device is operated. Examples of the carbon-based material include, but are not limited to, carbon nanotubes, graphite, diamond-like carbon, fullerene, and silicon carbide (SiC). Among these, carbon nanotubes are preferred.

The carbon nanotubes are carbon allotropes prepared by rolling graphite sheets to form tubes, which have diameters in the range of nanometers. Both single wall nanotubes and multi wall nanotubes can be used. The carbon nanotubes can be prepared using chemical vapor deposition (hereinafter, also called “CVD”), such as DC plasma CVD, RF plasma CVD, or microwave plasma CVD.

The photoelectric element converts optical energy into electric energy and increases the luminance of the electron emission source.

Electrons emitted from the carbon-based material contained in the electron emission source excite phosphors to emit light. The light can be emitted towards the bottom of the anode electrode as well as towards the top of the anode electrode. Light emitted towards the bottom travels to the electron emission source to transfer optical energy to the photoelectric element. Then, the photoelectric element converts the optical energy into electric energy to emit more electrons. The emitted electrons excite the phosphors to produce light. This cycle is repeated to increase the luminance of the electron emission source.

The photoelectric element may be any material that can convert optical energy into electrical energy. For example, the photoelectric element can include at least one element selected from the group consisting of Groups I, IIIA, and VA elements, O, Ag, Te, and I. Alternatively, a composite material composed of an alkaline metal, such as Li, Na, K, Rb, Cs, or Fr, and Ag, Bi, or Sb can be used. In particular, Cs—Sb and Cs—CsO—Ag are preferred due to their good secondary electron emission efficiency. More particularly, the photoelectric element may be selected from the group consisting of GaAs, Sb—Cs, Sb—Na—K—Cs, Sb—K—Cs, Ag—O—Cs, and Cs—I. In addition, MgO can be used. The photoelectric element may be composed of a transparent or semitransparent material which visible light permeates. By the photoelectric effect, photoelectrons are emitted when the photoelectric element absorbs light with a higher frequency than the threshold frequency of a photocathode. Thus, many materials other than the materials described above can be used as the photoelectric element as long as the photoelectric element has a lower threshold frequency than the frequency of visible light.

The photoelectric element may have a nanowire shape. A nanowire is an ultrafine wire having a diameter of several nm to tens of nm.

A weight ratio of the photoelectric element to the carbon-based material in the electron emission source may be 2:1 to 1:2. For example, the weight ratio may be 1:1. When the amount of the photoelectric element is less than the above-described range, the effect of increasing the luminance may be insignificant. When the amount of the photoelectric element exceeds the above-described range, the quantity of electrons initially emitted can be excessively reduced.

The electron emission source may include a small amount of a carbon deposit originating from a vehicle contained in a composition for forming electron emission sources, in addition to the carbon-based material and the photoelectric element. For example, the carbon deposit may be a result of a heat-treatment of the vehicle.

By the mechanisms described above, both the carbon-based material and the photoelectric element can emit electrons, and thus the luminance of the electron emission source can be increased.

A method of preparing electron emission sources according to an embodiment of the present invention includes: preparing a composition for forming electron emission sources that contains a carbon-based material, a photoelectric element, and a vehicle; applying the composition to a substrate; and heating the composition applied to the substrate. Typically, a plurality of electron emission sources are formed on a substrate at one time using the composition, but the method described herein applies as well to forming a single electron emission source.

First, a composition for forming electron emission sources that contains a carbon-based material, a photoelectric element, and a vehicle is prepared. The carbon-based material and the photoelectric element are as described above.

The vehicle contained in the composition for forming electron emission sources adjusts the printability and viscosity of the composition and carries the carbon-based material and the photoelectric element. The vehicle may contain a resin component and a solvent component.

The resin component may include, but is not limited to, at least one of cellulose-based resins, such as ethyl cellulose, nitro cellulose, etc., acrylic resins, such as polyester acrylate, epoxy acrylate, urethane acrylate, etc., and vinyl resins, such as polyvinyl acetate, polyvinyl butylal, polyvinyl ether, etc. Some of the above-listed resin components also can act as photosensitive resins.

The solvent component may include at least one of, for example, terpineol, butyl carbitol (BC), butyl carbitol acetate (BCA), toluene, and Texanol (a registered trademark of Eastman Chemical Company for 2,2,4-trimethyl-1,3-pentanediol monoisobutyrate). For example, the solvent component may include terpineol.

The amount of the resin component may be 100-500 parts by weight, and, for example, may be 200-300 parts by weight, based on 100 parts by weight of the carbon-based material. The amount of the solvent component may be 500-1500 parts by weight, and, for example, may be 800-1200 parts by weight, based on 100 parts by weight of the carbon-based material. When the amount of the vehicle composed of the resin component and the solvent component do not lie within the above-described ranges, the printability and the flowability of the composition deteriorate. When the amount of the vehicle exceeds the above-described range, the drying time may be too long.

The composition for forming electron emission sources according to the present invention may further include a photosensitive resin and a photoinitiator, an adhesive component, a filler, etc.

The photosensitive resin is used to pattern the electron emission sources. Non-limiting examples of the photosensitive resin include acrylic monomers, benzophenone monomers, acetophenone monomers, thioxanthone monomers, etc. In particular, epoxy acrylate, polyester acrylate, 2,4-diethyloxanthone, 2,2-dimethoxy-2-phenylacetophenon, etc., can be used as the photosensitive resin.

The amount of the photosensitive resin may be 300-1000 parts by weight, and, for example, may be 500-800 parts by weight, based on 100 parts by weight of the carbon-based material. When the amount of the photosensitive resin is less than 300 parts by weight based on 100 parts by weight of the carbon-based material, the exposure sensitivity decreases. When the amount of the photosensitive resin is greater than 1000 parts by weight based on 100 parts by weight of the carbon-based material, developing is not smooth.

The photoinitiator initiates cross-linking of the photosensitive resin when exposed to light. Non-limiting examples of the photosensitive resin include benzophenone, etc.

The amount of the photoinitiator may be 300-1000 parts by weight, and, for example, may be 500-800 parts weight, based on 100 parts by weight of the carbon-based material. When the amount of the photoinitiator is less than 300 parts by weight based on 100 parts by weight of the carbon-based material, crosslinking is not effective to form patterns. When the amount of the photoinitiator is greater than 1000 parts by weight based on 100 parts by weight of the carbon-based material, the manufacturing costs rise.

The adhesive component adheres the electron emission sources to the substrate. The adhesive component may be, for example, an inorganic binder, etc. Non-limiting examples of the inorganic binder include frit, silane, water glass, etc. A combination of at least two of these inorganic binders can be used. For example, the frit may be composed of PbO, ZnO, and B₂O₃.

The amount of the inorganic binder in the composition for forming electron emission sources may be 10-50 parts by weight, preferably 15-35 parts by weight, based on 100 parts by weight of the carbon-based material. When the amount of the inorganic binder is less than 10 parts by weight based on 100 parts by weight of the carbon-based material, the adhesion is not sufficiently strong. When the amount of the inorganic binder is greater than 50 parts by weight, the printability deteriorates.

The filler improves the conductivity of carbon-based material that is not strongly adhered to the substrate. Non-limiting examples of the filler include Ag, Al, Pd, etc.

The viscosity of the composition for forming electron emission sources according to an aspect of the present invention, which composition contains the above-described materials, may be 3,000-50,000 cps, preferably 5,000-30,000 cps. When the viscosity of the composition does not lie within the above range, it is difficult to handle the composition during processes.

Next, the composition for forming electron emission sources is applied to the substrate. The substrate on which electron emission sources will be formed may vary according to the type of an electron emission device to be formed, as would be apparent to a person skilled in the art. For example, when manufacturing an electron emission device with gate electrodes between cathode and anode electrodes, the substrate can be the cathode electrodes.

The applying of the composition for forming electron emission sources to the substrate may be carried out, for example, by a photolithography process using a photoresist pattern. In particular, after a photoresist pattern is formed on the substrate, the composition for forming electron emission sources is applied to the substrate on which the photoresist pattern has been formed. Next, exposure and developing process are performed to define desired electron emission source regions. The process of applying the composition for forming electron emission sources to the substrate is not limited to this method.

The composition for forming electron emission sources is heated after it is applied to the substrate as described above. Through the heat treatment, the adhesion of the carbon-based material and the photoelectric element in the composition to the substrate increases, the vehicle volatilizes, and the inorganic binder melts and solidifies, thereby improving the durability of the electron emission sources. The heat treatment temperature is determined according to the volatilization temperature and volatilization time of the vehicle contained in the composition for forming electron emission sources. The heat treatment temperature may be 400-500° C., and, for example, may be 450° C. When the heat treatment temperature is lower than 400° C., the volatilization of the vehicle, and other volatile components, is insufficient. When the heat treatment temperature is higher than 500° C., the manufacturing costs rise, and the substrate may be damaged.

The heat treatment process may be performed in the presence of an inert gas to minimize degradation of the carbon-based material. The inert gas may be, for example, nitrogen gas, argon gas, neon gas, xenon gas, or a mixture of these gases.

The heated structure is optionally subjected to an activation process for vertical orientation of carbon-based material and optionally, the photoelectric element. According to an embodiment, the activation process may be implemented by coating a solution which is curable in film form through a thermal process, for example, an electron emission source surface treatment containing a polyimide polymer, on the surface of the heated structure, thermally treating the coated structure to obtain a film; and separating the film. In another embodiment, the activation process may be implemented by pressing the surface of the heated structure at a predetermined pressure using a roller with an adhesive portion that is driven by a driving source. Such an activation process allows the carbon-based material to be exposed to the surface of the electron emission sources or to be vertically aligned.

The electron emission source according to an embodiment of the present invention may be an electron emission source prepared according to the method described above.

An electron emission device according to an embodiment of the present invention includes: a first substrate; a cathode electrode and an electron emission source which are arranged on the first substrate; a gate electrode which is arranged to be electrically insulated from the cathode electrode; and an insulating layer which is interposed between the cathode electrode and the gate electrode and insulates the cathode electrode and the gate electrode, wherein the electron emission source includes a carbon-based material and a photoelectric element. The electron emission source may be prepared according to the method described above. The electron emission device can have a high luminance since electrons can be further emitted due to the photoelectric element.

The electron emission device may further include an additional insulating layer that covers the gate electrode. In this case, a focusing electrode that is insulated from the gate electrode by the additional insulating layer and is arranged in parallel to the gate electrode. Thus, the electron emission device can have various structures.

The electron emission device can be used as, for example, a back light for liquid crystal displays (LCDs) or in electron emission display devices.

An electron emission display device according to an embodiment of the present invention includes: a first substrate; cathode electrodes arranged on the first substrate; gate electrodes arranged so as to cross the cathode electrodes; an insulating layer interposed between the cathode electrodes and the gate electrodes to insulate the cathode electrodes and the gate electrodes; electron emission source holes formed at the points at which the cathode electrodes cross the gate electrodes; an electron emission source contained in the electron emission source holes; a second substrate arranged in parallel to the first substrate; an anode electrode arranged on the second substrate; and a phosphor layer arranged on the anode electrode, in which the electron emission source includes a carbon-based material and a photoelectric element. The electron emission source may be prepared according to the method described above. Thus, the electron emission display can have a high luminance since electrons are further emitted due to the photoelectric element.

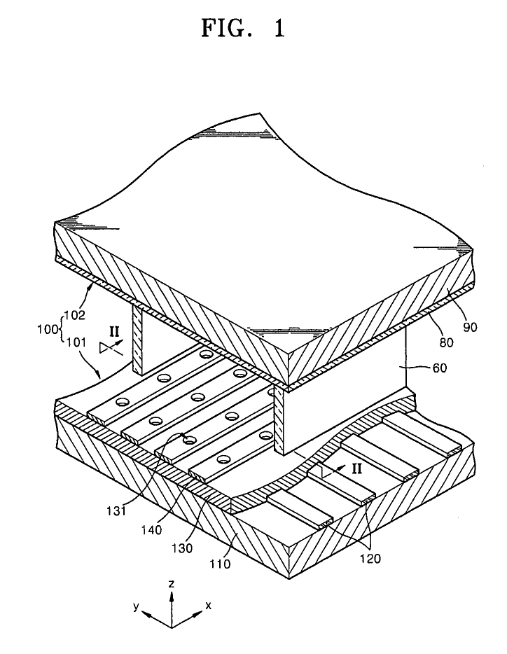

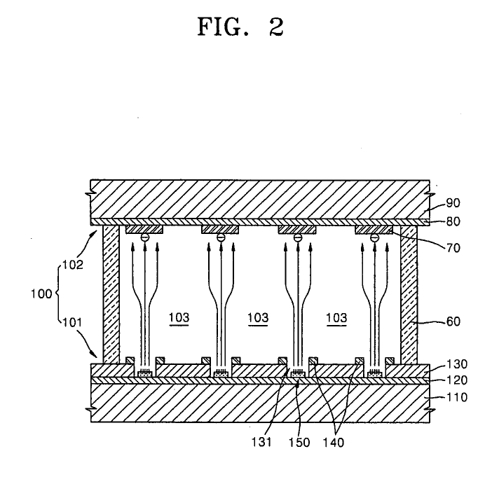

FIG. 1 is a schematic perspective view of a top gate type electron emission display device according to an embodiment of the present invention; and FIG. 2 is a cross-sectional view taken along the line II-II of FIG. 1.

Referring to FIGS. 1 and 2, an electron emission display device 100 includes an electron emission device 101 and a front panel 102 which form a light emission space 103, and a spacer 60 which maintains a distance between the electron emission device 101 and the front panel 102.

The electron emission device 101 includes: a first substrate 110; gate electrodes 140 and cathode electrodes 120 which are arranged to cross each other; and an insulating layer 130 interposed between the gate electrodes 140 and the cathode electrodes 120 to electrically insulate the gate electrodes 140 and the cathode electrodes 120.

Electron emission source holes 131 are formed in areas in which the gate electrodes 140 and the cathode electrodes 120 cross. An electron emission source 150 is contained in each electron emission source hole 131.

The front panel 102 includes: a second substrate 90; an anode electrode 80 arranged on a lower surface of the second substrate 90; and a phosphor layer 70 arranged on a lower surface of the anode electrode 80.

Although aspects of the present invention has been described with reference to the electron emission display shown in FIGS. 1 and 2, the present invention can also include electron emission displays with different structures such as, for example, an electron emission display further including an additional insulating layer and/or a focusing electrode. For example, a focusing electrode may be incorporated in the electron emission display by forming an second insulating layer on the gate electrode 140 and forming a focusing layer on the second insulating layer.

Hereinafter, aspects of the present invention will be described in greater detail with reference to the following examples. The following examples are for illustrative purposes and are not intended to limit the scope of the invention.

### EXAMPLE

1 g of carbon nanotube powder (available from CNI), 1 g of GaAs as a photoelectric element, 0.2 g of glass frits (8000L, Shinheung Ceramics), 0.2 g of polyester acrylate, and 5 g of benzophenone were added into 10 g of terpineol and stirred to obtain a composition for forming electron emission sources having a viscosity of 30,000 cps. The composition for forming electron emission sources was applied to electron emission source regions in a substrate on which Cr gate electrodes, an insulating layer, and ITO electrodes had been formed. The applied composition was exposed to light using a parallel exposure system at an exposure energy of 2000 mJ/cm². After the exposure process, the resulting structure was developed using acetone and heated at 450° C. in the presence of nitrogen gas to obtain electron emission sources. Next, a substrate with a phosphor layer and ITO anode electrodes thereon was arranged to face the substrate on which the electron emission sources had been formed, and spacers were formed between the two substrates to maintain a constant cell gap, thereby resulting in an electron emission display, referred to as Sample 1.

### Comparative Example

An electron emission display was manufactured in the same manner as in Example 1, except that GaAs was not used. The electron emission display was referred to as Sample 2.

Electron emission sources according to the present invention include a photoelectric element in addition to a carbon-based material. Thus, light produced from a phosphor layer by electrons initially emitted from the carbon-based material is converted into electrons by the photoelectric element and the electrons are emitted to excite the phosphor layer. This cycle can be repeated. Thus, an electron emission device and an electron emission display including the electron emission sources can have a high luminance.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An electron emission source comprising a carbon-based material and a photoelectric element.

2. The electron emission source of claim 1, wherein the photoelectric element comprises at least one element selected from the group consisting of Groups I, IIIA, and VA elements, O, Ag, Te, and I.

3. The electron emission source of claim 1, wherein the photoelectric element is selected from the group consisting of GaAs, Sb—Cs, Sb—Na—K—Cs, Sb—K—Cs, Ag—O—Cs, and Cs—I.

4. The electron emission source of claim 1, wherein the photoelectric element is made of a composite material consisting of at least one alkaline metal and at least one of Ag, Bi, and Sb.

5. The electron emission source of claim 1, wherein the photoelectric element is made of a material selected from Cs—CsO—Ag and MgO.

6. The electron emission source of claim 1, wherein the photoelectric element is a material having a threshold frequency lower than the frequency of visible lights.

7. The electron emission source of claim 1, wherein the photoelectric element has a nanowire shape.

8. The electron emission source of claim 1, wherein the carbon-based material is carbon nanotube, graphite, diamond-like carbon, fullerene, or silicon carbon (SiC).

9. The electron emission source of claim 1, wherein a weight ratio of the carbon-based material to the photoelectric element is 2:1 to 1:2.

10. A method of preparing electron emission sources, the method comprising:
preparing a composition for forming electron emission sources that contains a carbon-based material, a photoelectric element, and a vehicle;
applying the composition to a substrate; and
heating the composition applied to the substrate.

11. The method of claim 10, wherein the applying the composition is performed by coating the composition on the substrate and performing exposure and developing processes to define desired electron emission source regions.

12. An electron emission device comprising:
a first substrate;
a cathode electrode and an electron emission source arranged on the first substrate;
a gate electrode which is arranged so as to be electrically insulated from the cathode electrode; and
an insulating layer which is interposed between the cathode electrode and the gate electrode and insulates the cathode electrode and the gate electrode,
wherein the electron emission source comprises a carbon-based material and a photoelectric element.

13. The electron emission device of claim 12, further comprising an additional insulating layer which covers the gate electrode and a focusing electrode which is insulated from the gate electrode and is arranged in parallel to the gate electrode.

14. An electron emission display device comprising:
a first substrate;
a plurality of cathode electrodes arranged on the first substrate;
a plurality of gate electrodes arranged so as to cross the cathode electrodes;
an insulating layer interposed between the cathode electrodes and the gate electrodes to insulate the cathode electrodes and the gate electrodes;
electron emission source holes formed at the points at which the cathode electrodes and the gate electrodes cross;
an electron emission source contained in the electron emission source holes;
a second substrate arranged in parallel to the first substrate;
an anode electrode arranged on the second substrate; and
a phosphor layer arranged on the anode electrode,
wherein the electron emission source comprises a carbon-based material and a photoelectric element.

15. The electron emission display device of claim 14, wherein the phosphor layer and the electron emission source are positioned with respect to each other such that in an operation of the electron emission display device, a repeating cycle is created wherein electrons emitted by the electron emission source excite phosphors of the phosphor layer to produce light that interacts with the photoelectric element to produce electrons that are emitted by the electron emission source.
